(19) United States
(12) Patent Application Publication
(10) Pub. No.: US 2019/0186703 A1
(43) Pub. Date: Jun. 20, 2019

(54) SOLAR LIGHT SYSTEMS

(71) Applicant: Adrian Kruse, Petaluma, CA (US)

(72) Inventor: Adrian Kruse, Petaluma, CA (US)

(21) Appl. No.: 16/226,537

(22) Filed: Dec. 19, 2018

Related U.S. Application Data
(60) Provisional application No. 62/607,702, filed on Dec. 19, 2017.

(51) Int. Cl. F21S 9/03; F21V 23/04; F21S 6/00; H05B 33/08

(52) U.S. Cl. CPC F21S 9/032; H05B 33/0809; F21S 6/005; F21V 23/0442

(57) ABSTRACT

A solar light system which provides users with indoor lighting capable of operating via a solar-powered battery. The system includes a solar cell unit on a top portion, which gathers energy through bright sunlight during daytime hours. The system further includes a lighting assembly including the solar cell unit, an illumination member, a transparent housing, a support base, a battery-power supply, a control unit, and internal processing equipment. The system is configured with decorative and functional designs to provide a light source that is practical, functional, artistic, inexpensive, and safe for all ages.

### CROSS REFERENCE TO RELATED APPLICATION

The present application is related to and claims priority to U.S. Provisional Patent Application No. 62/607,702 filed Dec. 19, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of illumination and more specifically relates to solar powered lighting.

### 2. Description of Related Art

In the field of lighting systems, in the current state of the art, most lighting systems are either indoor lighting systems or outdoor lighting systems such as indoor lamps or other types of lighting assemblies, and outdoor assemblies which are of the type which are placed strategically either mounted exteriorly or placed within the ground as a ground lighting system. Solar powered lights have been used for various purposes and particularly for outdoor lights on sidewalks, patios, lawns and the like. Electricity can be an expensive commodity, especially with homes and offices with numerous light fixtures. Solar power is an efficient, environmentally-friendly method of providing power to electrical devices; however, it may be difficult to fully light a home/office using solar energy. People may spend an exorbitant amount of money on electricity and may be looking for additional ways to illuminate certain rooms at night. A suitable solution is desired.

U.S. Pub. No. 2011/0089839 to Chung-Chia Chen relates to a system and method of indoor solar illumination. The described system and method of indoor solar illumination includes a system and method especially of using solar electricity for indoor illumination utilizes solar energy generated electricity in solar panel which installed indoor side of window, door of building and the electricity generated stored and connected to the indoor illumination device. The system consisting of at least one solar panel, storage means (battery), an electric switch, a light-sensitive resistor and at least an illumination device (lighting fixture). The electric switch and light-sensitive resistor enables or disables the electrical connection between the battery and the illumination device depending on the degree of brightness/darkness indoor as needed.

### BRIEF SUMMARY OF THE INVENTION

In view of the foregoing disadvantages inherent in the known illumination art, the present disclosure provides a novel solar light system. The general purpose of the present disclosure, which will be described subsequently in greater detail, is to provide users with indoor lighting capable of operating via a solar-powered battery.

A solar light system is disclosed herein. The solar light system includes a lighting assembly having a solar cell unit, an illumination member, a transparent housing, a removeable support base, a battery-power supply, and a control unit. The solar cell unit is positioned on a top-portion of the lighting assembly and is configured to collect renewable energy and power the illumination member. The illumination member is housed within the transparent housing and is configured to emit light therethrough when activated. The lighting assembly is removably coupled to the support base. The control unit may include an activation button and may further comprise a sensory apparatus for detecting darkness and automatically activating the illumination member. The solar light system provides an indoor illumination device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, solar light systems, constructed and operative according to the teachings of the present disclosure.

FIG. 1 is a perspective view of the solar light system during an ‘in-use’ condition, according to an embodiment of the disclosure.

FIG. 2 is a perspective view of the solar light system of FIG. 1, according to an embodiment of the present disclosure.

FIG. 3 is a perspective view of the solar light system of FIG. 1, according to an embodiment of the present disclosure.

FIG. 4 is a perspective view of the solar light system of FIG. 1, according to an embodiment of the present disclosure.

FIG. 5 is a perspective view of the solar light system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to illumination and more particularly to a solar light system as used to improve the use of solar powered lighting.

Generally, solar light system may comprise an indoor decorative design, light emitting assembly, sensory apparatus, battery power supply, solar cell, and internal processing equipment. In a preferred embodiment, the lighting device may resemble the structure of commonly used outdoor decorative solar lights. The device may be used as a standalone lighting instrument placed near windows or awnings that receive natural sunlight throughout the day. The device may thereby collect power from the embedded solar cell during the daytime to be used at a later point. The internal processing equipment may automatically turn the indoor solar powered lighting device on when the sensory apparatus detects that it is dark in the nearby surroundings.

The present invention provides users with indoor lighting capable of operating via a solar-powered battery. It features a solar panel on the top portion, which gathers energy through bright sunlight during daytime hours. It includes a weighted, interchangeable base that allows users to customize the look of the lights at any desired time. The indoor solar lights enhance the atmosphere of any room while offering efficient lighting for working, playing, and the like. The device of this present system may comprise an indoor decorative design, light emitting assembly, sensory apparatus, battery power supply, solar cell, and internal processing equipment.

In a preferred embodiment, the lighting device may resemble the structure of commonly used outdoor decorative solar lights. The device may be used as a standalone lighting instrument placed near windows or awnings that receive natural sunlight throughout the day. The device may thereby collect power from the embedded solar cell during the daytime to be used at a later point. The internal processing equipment may automatically turn the indoor solar powered lighting device on when the sensory apparatus detects that it is dark in the nearby surroundings.

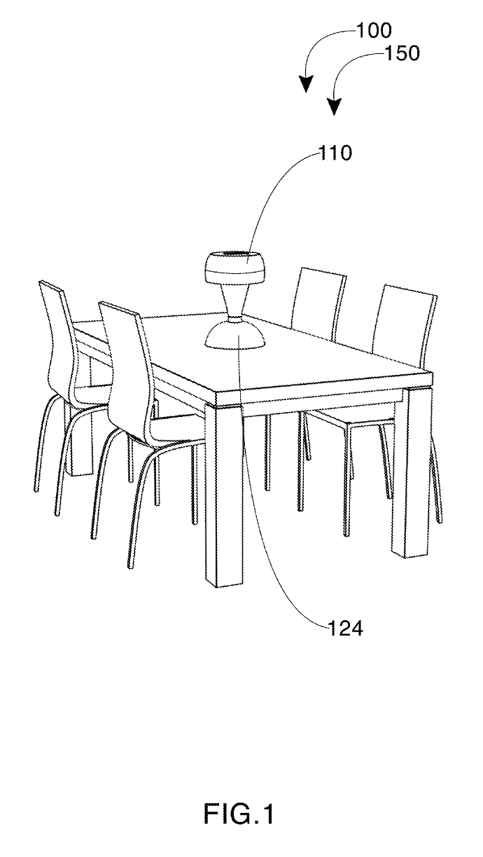

Referring now more specifically to the drawings by numerals of reference, there is shown in FIGS. 1-5, various views of a solar light system 100. FIG. 1 shows a solar light system 100 during an ‘in-use’ condition 150, according to an embodiment of the present disclosure. As illustrated, the solar light system 100 may include a lighting assembly 110 including a solar cell unit 112, an illumination member 116, a transparent housing 120, a support base 124, a battery-power supply 128, and a control unit 132. The solar cell unit 112 is positioned on a top-portion 114 of the lighting assembly 110 and is configured to collect renewable energy and power the illumination member 116. The illumination member 116 is housed within the transparent housing 120 and is configured to emit light therethrough when activated. The lighting assembly 110 is removably coupled to the support base 124. The control unit 132 is configured to control activation and deactivation of the lighting assembly 110. The solar light system 100 provides an indoor illumination device.

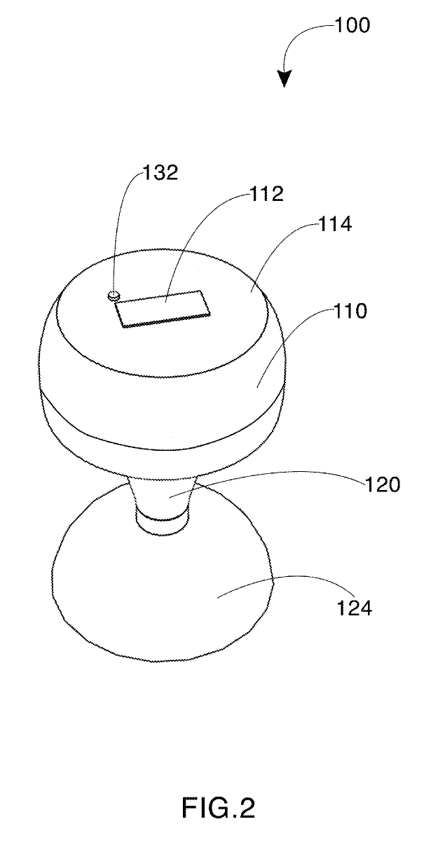

FIG. 2 shows a perspective view of the solar light system 100 of FIG. 1, according to an embodiment of the present disclosure. As above, the solar light system 100 may include the lighting assembly 110 comprising the solar cell unit 112, the illumination member 116, the transparent housing 120, the support base 124, the battery-power supply 128, and the control unit 132 for providing efficient, low-cost indoor lighting. The illumination member 116 includes at least one light bulb. The battery-power supply 128 provides a back-up power source in a case that the illumination member 116 cannot be powered by the renewable energy collected by the solar cell unit 112. The battery-power supply 128 is embedded in the top-portion 114 of the lighting assembly 110 and may be removeable and replaceable. The solar light system 100 is rechargeable via sunlight and the solar cell unit 112. A user may place the device in sunlight for recharging the device.

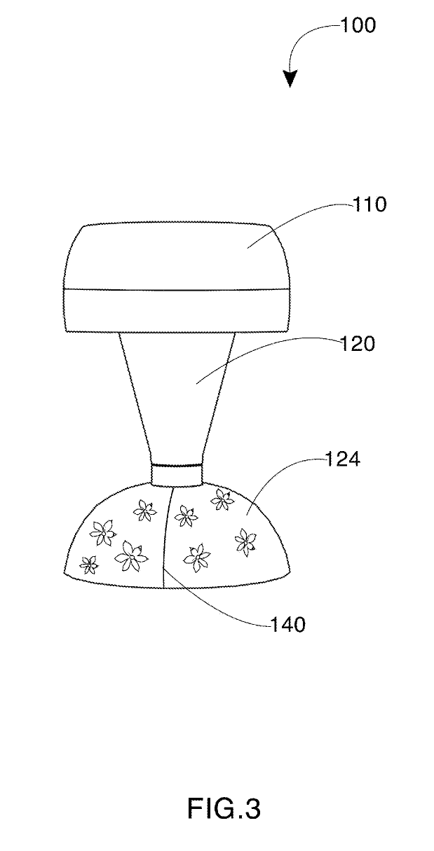

FIG. 3 shows a perspective view of the solar light system 100 of FIG. 1, according to an embodiment of the present disclosure. As above, the solar light system 100 may include an indoor lighting solution capable of operating via a solar power. The device includes the lighting assembly 110 and the removeable support base 124. The control unit 132 of the device comprises an activation button for activating and alternatively deactivating the illumination member 116. The activation button may be positioned on the top-portion 114 of the lighting assembly 110. The control unit 132 may further comprise a sensory apparatus for detecting darkness and automatically activating the illumination member 116 when darkness is sensed.

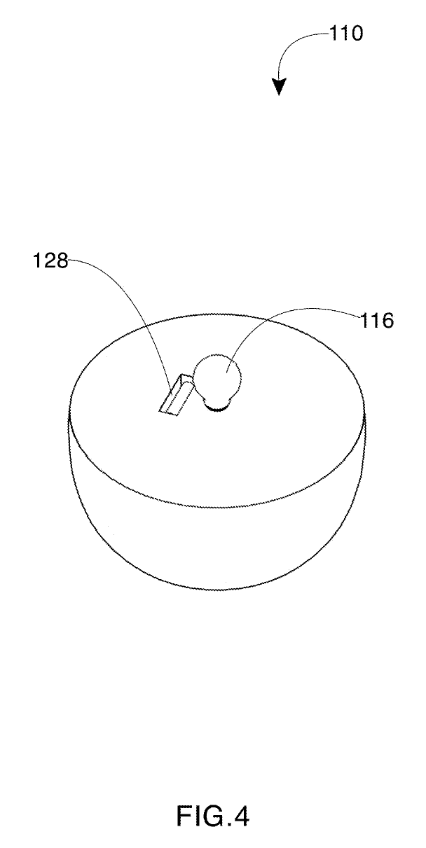

FIG. 4 shows a perspective view of the solar light system 100 of FIG. 1, according to an embodiment of the present disclosure. As above, the solar light system 100 may include an outer shell 140 which is removeable attachable to the support base 124 to alter an appearance of the support base 124. The outer shell 140 contours to a profile of the support base 124. The outer shell 140 may include decorative and functional indicia, 3-dimensional items, various designs, and colors. It offers an environmentally-friendly, functional and decorative way to illuminate a home, office, and more, reducing the amount of money spent on electrical costs.

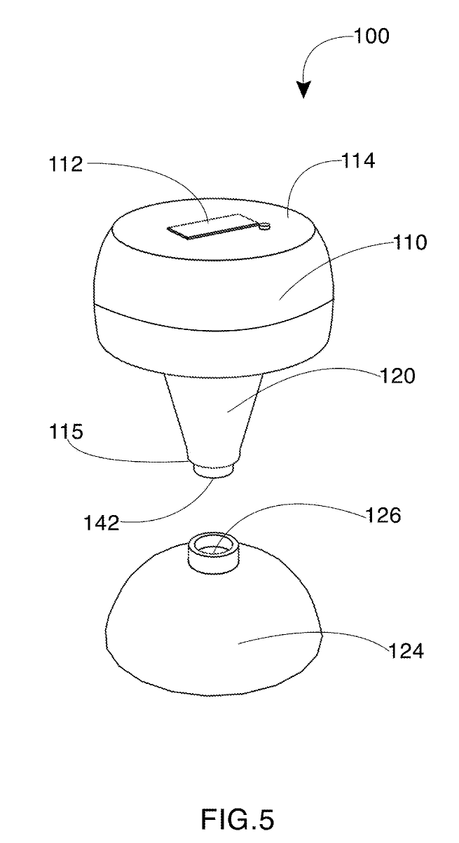

FIG. 5 shows a perspective view of the solar light system 100 of FIG. 1, according to an embodiment of the present disclosure. As above, the solar light system 100 may include the lighting assembly 110 comprising the solar cell unit 112, the illumination member 116, the transparent housing 120, the support base 124, the battery-power supply 128, and the control unit 132 in functional combination. The support base 124 comprises a greater diameter than the top-portion 114, such that the support base 124 supports the indoor illumination device stably on a planar surface. The support base 124 comprises an aperture 126 for receiving a connection-member 142 of the lighting assembly 110 and supporting the lighting assembly 110. The connection-member 142 is positioned on a bottom portion 115 of the lighting assembly 110 opposing the top-portion 114. In a preferred embodiment, the support base 124 and the top-portion 114 are substantially opaque. The transparent housing 120 preferably comprises a conical profile which tapers towards the support base 124. The overall parts of the device work in conjunction to create shadows of light in unique patterns to provide a comfortable ambience in a room. The solar light system 100 is a portable, stand-alone indoor illumination device.

Upon reading this specification, it should be appreciated that, under appropriate circumstances, considering such issues as user preferences, design preference, structural requirements, marketing preferences, cost, available materials, technological advances, etc., other solar power and electrical arrangements such as, for example, powering means, electrical components, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A solar light system comprising:
a lighting assembly including;
a solar cell unit;
an illumination member; and
a transparent housing;
a support base;
a battery-power supply; and
a control unit;
wherein said solar cell unit is positioned on a top-portion of said lighting assembly and is configured to collect renewable energy and power said illumination member;
wherein said illumination member is housed within said transparent housing and is configured to emit light therethrough when activated;
wherein said lighting assembly is removably coupled to said support base;
wherein said control unit is configured to control activation and deactivation of said lighting assembly; and
wherein said solar light system provides an indoor illumination device.

2. The solar light system of claim 1, wherein said illumination member includes at least one light bulb.

3. The solar light system of claim 1, wherein said battery-power supply provides a back-up power source.

4. The solar light system of claim 1, wherein said battery-power supply is embedded in said top-portion of said lighting assembly.

5. The solar light system of claim 1, wherein said solar light system is rechargeable via sunlight and said solar cell unit.

6. The solar light system of claim 1, wherein said control unit comprises an activation button for activating and alternatively deactivating said illumination member.

7. The solar light system of claim 6, wherein said activation button is positioned on said top-portion of said lighting assembly.

8. The solar light system of claim 1, wherein said control unit further comprises a sensory apparatus for detecting darkness and automatically activating said illumination member.

9. The solar light system of claim 1, wherein said support base comprises an aperture for receiving a connection-member of said lighting assembly and supporting said lighting assembly.

10. The solar light system of claim 9, wherein said connection-member is positioned on a bottom portion of said lighting assembly opposing said top-portion.

11. The solar light system of claim 1, wherein said support base comprises a greater diameter than said top-portion, such that said support base supports said indoor illumination device stably on a planar surface.

12. The solar light system of claim 11, wherein said solar light system is a stand-alone said indoor illumination device.

13. The solar light system of claim 1, further includes an outer shell which is removeable attachable to said support base to alter an appearance of said support base.

14. The solar light system of claim 13, wherein said outer shell contours to a profile of said support base.

15. The solar light system of claim 13, wherein said outer shell includes decorative and functional indicia.

16. The solar light system of claim 15, wherein said indicia includes 3-dimensional items.

17. The solar light system of claim 1, wherein said support base and said top-portion are substantially opaque.

18. The solar light system of claim 1, wherein said transparent housing comprises a conical profile.

19. The solar light system of claim 18, wherein said transparent housing tapers towards said support base.

20. A solar light system, the solar light system comprising:
a lighting assembly including;
a solar cell unit;
an illumination member; and
a transparent housing;
a support base;
a battery-power supply; and
a control unit;
wherein said solar cell unit is positioned on a top-portion of said lighting assembly and is configured to collect renewable energy and power said illumination member;
wherein said illumination member is housed within said transparent housing and is configured to emit light therethrough when activated;
wherein said lighting assembly is removably coupled to said support base;
wherein said control unit is configured to control activation and deactivation of said lighting assembly;
wherein said solar light system provides an indoor illumination device;
wherein said illumination member includes at least one light bulb;
wherein said battery-power supply provides a back-up power source;
wherein said battery-power supply is embedded in said top-portion of said lighting assembly;
wherein said solar light system is rechargeable via sunlight and said solar cell unit;
wherein said control unit comprises an activation button for activating and alternatively deactivating said illumination member;
wherein said activation button is positioned on said top-portion of said lighting assembly;
wherein said control unit further comprises a sensory apparatus for detecting darkness and automatically activating said illumination member;
wherein said support base comprises an aperture for receiving a connection-member of said lighting assembly and supporting said lighting assembly;
wherein said connection-member is positioned on a bottom portion of said lighting assembly opposing said top-portion;
wherein said support base comprises a greater diameter than said top-portion, such that said support base supports said indoor illumination device stably on a planar surface;
wherein said solar light system is a stand-alone said indoor illumination device;
wherein said solar light system further includes an outer shell which is removeable attachable to said support base to alter an appearance of said support base;
wherein said outer shell contours to a profile of said support base;
wherein said outer shell includes decorative and functional indicia;
wherein said support base and said top-portion are substantially opaque;
wherein said transparent housing comprises a conical profile; and
wherein said transparent housing tapers towards said support base.
